(19) United States
(12) Patent Application Publication
(10) Pub. No.: US 2007/0059429 A1
(43) Pub. Date: Mar. 15, 2007

(54) Protein powder and protein-containing drink obtained therefrom

(75) Inventors: Hans-Peter Wild, Eppelheim (DE); Thomas Eller, Berlin (DE); Matthias Sass, Oftersheim (DE); Susanne Rimmler, Plankstadt (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Rudplf Wild GmbH & Co. KG, hEIDELBERG (DE)

(21) Appl. No.: 10/575,440

(22) PCT Filed: Sep. 30, 2004
(86) PCT No.: PCT/EP04/10931

§ 371 Date: Oct. 3, 2006

(30) Foreign Application Priority Data
Oct. 20, 2003 (DE) 103 48 539.2

(51) Int. Cl. A23J 1/00

(52) U.S. Cl. 426/656

(57) ABSTRACT

The invention relates to a protein powder which contains at least one protein source and a stabilizer, selected from esterified pectin and/or carboxymethyl cellulose, which is obtainable by mixing a protein source with a stabilizer, heating the mixture, homogenizing the mixture, and drying the mixture, thereby obtaining a powder. The invention also relates to a method for producing said protein powder, a method for producing a protein-containing drink using said protein powder and a protein-containing drink obtained by said method.

The present invention refers to a protein powder, a method of producing this protein powder and the use of this protein powder for producing a protein-containing drink with improved shelf life. The present invention further refers to a method of producing a protein-containing drink as well as the protein-containing drink obtained therefrom.

Opacifiers are often used in food industry in the production of drinks, e.g. of refreshment drinks or fruit juice products. The opacifiers activate a desired opacity effect which implies that the drink has a fruit juice portion. Opacifiers activate an opacity or contribute in an opacity, however they shall not influence the stability, they shall not form a ring on the bottle neck or deposit on the bottom (sedimentation). Examples of know opacifiers include cut citrus fruits from which the juice is extracted or citrus shell extracts with or without the addition of herbal fats, carrier substances, phosphate, possibly synthetic flavorings or micro-encapsulated citrus oils. Brominated vegetable oils are also known as opacifiers in drinks and cold-soluble dry mixtures. The use of these brominated vegetable oils, however, decreased due to health regulations and the increasing interest of the consumers in healthier drinks.

Thus, the use of stable proteins as opacifier and dietary supplement was taken into consideration. Examples of the proteins include amongst others dairy proteins and whey proteins but also proteins on herbal basis, such as soy proteins. The disadvantage of the proteins is that they are insoluble at or close to the isoelectric point and that they fall out, which has a negative effect on their suitability as opacifier in acidic drinks. This leads to the consequence that the proteins in this state are not suitable as opacifier.

In the development of an opacifier, which does not affect the color or the taste of the drink, stable soy protein particles were developed by Klavons et al. (J Food Sci 57 4 945-947(1992)) in which the soy protein forms a stable opacity only if soluble pectin existed in the incubation medium when the particles formed. This result was optimized by Jasentuliyana et al. (J Sci Food Agric 78 389-394 (1998)) to determine the best relation of pectin to the soy protein fraction, which resulted in the most stable opacity.

In these scientific studies the known stabilizing effect of proteins, particularly protein of milk or whey and soy proteins is utilized by pectin, particularly pectin with a high esterification degree. The stabilizing principle is the protective colloid effect of the pectin around the protein molecules. Thus, it is achieved that despite a lowering of the pH-value below the isoelectric point a stable protein dispersion by the aid of homogenization can be achieved. As described above, the caseins for example of cow milk would irreversibly denaturize at the isoelectric point (pH 4.6) and would fall out.

The essential method steps in the above-mentioned methods of manufacturing stable opacifiers on protein basis will now be listed as an example:
solving the pectin in water or directly in milk,
heating to hydrate the pectin,
slowly adding an acid to lower the pH value,
heating e.g. to 90° C.
two-stage homogenization, e.g. at 250 bar/50 bar,
cooling e.g. to 20° C.

The liquid product is then used directly to produce drinks.

This shows that the above-mentioned method requires a relatively high technical expenditure in order to obtain a stable product as opacifier. Moreover, satisfactory results in the fruit juices are only achieved by this method if the protein-containing raw material exists in fresh form, i.e. if fresh cow milk or soy milk is used. If a milk powder is used instead of the milk, stabilization becomes very difficult or even impossible, since the protein structures are irreversibly damaged by drying. The formation of a ring or sedimentation of the opacifier occurs within a short period of time.

For an industrial processing, the use of a powder in drink production is, however, advantageous in view of shelf-life and storage and also with respect to the saving of space compared to fresh goods. There is an economic interest in using not only the protein-containing raw material in fresh form but also in dried form for an opacifier for drinks.

The stability of the drinks obtained by a protein-containing raw material in dried form may be improved by modification of the stabilizer quantity, the homogenization conditions and the number of homogenization cycles within certain boundaries. However, durability is not achieved that would be suitable for marketing drink products in a large scale.

Dried protein powder and its use for drinks is, however, commonly known. In Food-Technology 55(12), 65 (2001) the use of a pure soy protein powder for drinks is described. The use of this protein powder leads to improved sensory properties, such as mouth feeling and physical properties, such as viscosity and the ability to emulsify. A use for acidic drinks is not mentioned.

An aroma intensifier, which is made of soy protein, is described in U.S. Pat. No. 6,190,709, wherein this intensifier is particularly suitable amongst others for drinks. In this case, improved properties with respect to texture, mouth feeling and viscosity are also asserted.

In Food-Hydrocolloids, 10(4), 431-439 (1996) the application of whey protein-stabilized emulsions is described. Physical properties, such as dispersibility, wettability and emulsion stability are discussed. In this case the whey protein itself acts as a stabilizer for the emulsion, whereas the stabilization of the protein is not discussed. Moreover, influential factors on the preservation of the properties of the spray-dried material are shown.

Thus, protein powders, protein isolates or fractions of soy and milk were predominantly known with respect to the emulsion ability, solubility and sensory properties (smell, taste, mouth feeling). An optimized function in view of the application in the acid pH range, particularly in drinks was not described up to now.

Moreover, the stabilizing effect of carboxylmethylcellulose in proteins, particularly in whey, milk and soy proteins, is known. Such stabilizing effects and the formation of protein carboxylmethylcellulose complexes is for instance described in Gerard M. et. Al., Journal of Food Science 2002, 67 (1) 113-119; Arvind et al., Process Biochemistry 2000, 35 (8), 777-785 and Delben S. et al., Journal of Food Engineering 1997, 33(3), 325-346. Diftis N. et al. describe in Food Chemistry 2003, 81, 1-6 the improvement of the emulsion properties of a soy been protein isolator by conjunction with carboxylmethylcellulose. For this purpose the soy bean protein isolate is mixed with carboxylmethylcellulose and is heated dry at 60° C. up to 5 weeks. The use of soy proteins is described for certain food, such as mayonnaise, salad cream, milk and cream. The use in drinks, particularly in drinks in the acid pH range is not mentioned.

Thus, it is the object of the present invention to provide stable opacifiers or dietary supplements with a good shelf-life, which can be used in drinks, particularly in fruit drinks or fruit juice containing drinks and which can ensure a long shelf life of this drink. At the same time these opacifiers or dietary supplements shall not affect the taste or color of the drink and shall not cause any potential health risks.

This object is solved by a protein powder containing at least one protein source and one stabilizer, selected for esterified pectin and/or carboxylmethylcellulose, which can be obtained by:
mixing a protein source with a stabilizer
heating the mixture,
homogenizing the mixture and
drying the mixture to obtain a powder.

Moreover, the present invention refers to a method of producing a protein powder, including at least one protein source and one stabilizer selected from esterified pectin and/or carboxylmethylcellulose, comprising the following steps:
mixing a protein source with a stabilizer,
heating the mixture,
homogenizing the mixture and
drying the mixture to obtain a powder.

The invention also refers to the use of this protein powder to produce a protein-containing drink.

As a further aspect the present invention refers to a method of producing a protein-containing drink, comprising the steps of:
solving the above obtained protein powder in a liquid medium,
heating the liquid and
homogenizing the liquid.

Moreover, the present invention refers to a protein-containing drink, which can be obtained by this method:
solving the above obtained protein powder in a liquid medium,
heating the liquid, and
homogenizing the liquid.

As a further aspect the present invention refers to a method of producing a protein-containing drink, comprising the following steps:
solving the above obtained protein powder in a liquid medium,
use for instant consumption.

Moreover, the present invention refers to a protein-containing drink which can be obtained by this method.

The invention will now be described in detail in view of the preferred embodiments.

Surprisingly it was found that the protein-powder according to the invention differs from conventional protein powders, since for the first time a stable opacifier or dietary supplement in powder form can be provided which is stable in acid milieu. If this protein powder is used in the production of drinks, particularly in the production of fruit juices and fruit juice containing drinks, the opacity remains stable over a long period of time, and an improved shelf-life is achieved not only with respect to opacifiers made of conventional protein powders, but also made of fresh goods, such as cow milk or soy milk. This effect was completely surprising, since caused by the heat strain of the protein in the production of the powder, particularly during the drying step, a damage of the protein had to be expected. The protein-containing drink that is thus available therefore differs in view of its inner composition from known protein-containing drinks that are produced as refreshment drinks, since a long shelf-life at normal temperatures and an acid pH value were observed for the first time.

It was shown that the above-mentioned method steps in the production of the protein powder according to the invention have the effect that the protein source together with the above described stabilizer exist in a different structural composition than if the protein powder and the stabilizer in powder form are only mixed with one another. Thus, it is assumed that by the method steps carried out according to the invention a change in structure between the protein source and the stabilizer sets in, which is responsible for the improved properties.

The protein powder according to the invention includes at least one protein source. The protein source is proteins existing in liquid form. This may be one single type of protein or a mixture of proteins. A mixture of proteins is obtained if a protein source contains several proteins or in that individual protein sources are mixed with one another. The protein may be any protein. In view of the fact that the protein powder according to the invention shall be used in the food industry, the protein should be harmless to health. The protein may be a herbal-based or animal-based protein. Preferred protein sources on animal basis include milk of animal origin, such as cow milk, sheep milk, goat milk or mare milk as well as whey. As protein sources on herbal basis, soy milk, oat milk and rice milk are particularly suitable. Especially preferred are cow milk, soy milk or whey. The protein source may besides its natural form also be diluted or concentrated as long as this does not affect the mixing with the stabilizer.

The expression “soy milk”, “rice milk” and “oat milk” are used within this application several times and designate an aqueous extract of ground soy beans, rice or oat grains. The products obtained thereby are designated in the USA as “soy milk”, “rice milk” or “oat milk” and apply as herbal alternatives to animal milk. Particularly soy milk established among allergic persons and vegans as a substitute for animal milk. In Germany, the expressions “Sojamilch” (soy milk), “Reismilch” (rice milk) and “Hafermilch” (oat milk) as product names are not allowable due to legal restrictions. Analog products, which are on the market in Germany, are e.g. designated as “soy beverage” or “soy drink”.

Preferably, the protein source is selected of milk of animal original, soy milk, whey and mixtures thereof. Especially preferred are cow milk and soy milk, particularly soy milk.

The amount of protein source in the protein powder according to the invention is not particularly restricted. In view of the suitability of the protein powder according to the invention to produce an opacifier or dietary supplement the amount of protein in the protein powder is usually at 10 to 95 percent by weight, even more preferred at 10 to 90 percent by weight, especially preferred at 15 to 85 percent by weight and mostly preferred is a quantity of 20 to 75 percent by weight.

Moreover, the protein powder according to the invention contains a stabilizer selected from esterified pectin and/or carboxylmethylcellulose. As mentioned above, the stabilizer serves for stabilizing the protein source or the mixture. The stabilizer binds with the protein and forms a protective colloid around the protein molecules. This prevents an aggregation of the protein molecules during drying, which leads to a stability of the opacity within the drink. The protein powder according to the invention has an improved stability, which gives rise to the assumption that the protective effect of the stabilizer is achieved in a more effective way.

The type of pectin is not particularly restricted as long as the above-mentioned property of the pectin to stabilize the protein is not affected. Pectin is a linear polysaccharide of α-1,4-linked D-galacturonic acid molecules partially esterified with methanol. The molar mass is approximately 20,000 to 100,000 g/mol. For the protein powder according to the invention, pectins with a higher molar mass are preferred. Thus, the molar mass is preferably 40,000 to 100,000 g/mol, even more preferred 60,000 to 100,000 g/mol.

The pectin may be of natural or synthetic origin. Due to its availability, natural pectins are preferred. Particularly apple pectin, which is obtained during the apple juice production, citrus pectin, which is obtained during the citrus juice production but also pectin of sunflower crowns and sugar beet snippets are common. Apple and citrus pectin are especially preferred.

As described above, the free carboxyl groups of the pectin are partially esterified with methanol. The esterification degree shall be above 50%. Preferred is an esterification degree of 60 to 90%, even more preferred 70 to 85%, most preferred 72 to 80%. Pectin having the above-mentioned esterification degrees is commercially available and may be set by the manufacturer if desired.

The type of carboxylmethylcellulose is not particularly restricted as long as the above-mentioned property of the carboxylmethylcellulose to stabilize the protein is not affected. Carboxymethylcellulose is the glycol acid ether of the cellulose and preferably exists in the form of the sodium salt. The mean molecular weight is approx. 80,000 to 800,000, preferably 100,000 to 400,000, even more preferred 200,000 to 300,000. The substitution degree is 0.5 to 1.5, preferably 0.7 to 1.2, most preferred 0.7 to 0.9. Carboxylmethylcellulose is commercially available having these properties and can accordingly be selected.

The amount of stabilizer, which exists together with the protein in the protein powder according to the invention, should be sufficient to ensure a stabilization of the protein in acidic refreshment drinks. Preferably, the amount of stabilizer lies in a range that is common to stabilize the protein molecules. Preferred amounts of the stabilizer in the protein powder are at 0.5 to 40 percent by weight, even more preferred 1 to 30 percent by weight, especially preferred at 2 to 25 percent by weight, and mostly preferred at 4 to 20%.

The protein powder may also contain other ingredients that are common for this purpose. The protein powder according to the invention may besides protein and the stabilizer also contain aromas, culinary acids, fillers, vitamins, antioxidants, colorants and/or acid regulators.

The essential difference of the protein powder according to the invention compared to conventional opacifiers on protein basis is that the protein source or the mixture with the stabilizer are subjected to a procedure in liquid state, which has a positive effect on the properties of the protein powder obtained. The protein molecules are modified together with the stabilizer molecules in a manner that even in the case of an acid pH value a high stability of the protein powder after drying and re-dilution is obtained.

The essential method steps were explained above and will now be described in more detail.

First of all, the protein source or the mixture including a stabilizer selected from esterified pectin and/or carboxylmethylcellulose is mixed. Since the protein source is liquid itself, further liquid does not have to be added. If the protein source exists in concentrated form, it is, however, preferred that the components are additionally mixed in a liquid medium. The liquid medium is preferably water. Especially preferred it is de-ionized water. Preferably, the components, if the protein source exists in concentrated form, are solved in 1 to 50 percent by weight of de-ionized water, especially preferred in 3 to 43 percent by weight, most preferred in 5 to 40 percent by weight of de-ionized water.

The stabilizer is solved in the protein source or in the protein source and the liquid medium. If a liquid medium is used, the protein source is preferably added to the liquid medium and subsequently the stabilizer is added to solve it.

Subsequently, the mixture is heated. Thus, the mixture is preferably heated to a temperature of 70 to 95° C., especially preferred to 85 to 95° C., mostly preferred to 90° C.

The heating is usually carried out for a period of time of 0.1 to 5 minutes, preferably 0.2 to 4 minutes, even more preferred 0.3 to 3 minutes, mostly preferred 0.5 to 2 minutes. This heating step serves for preservation but also for complete hydratization and swelling of the pectin.

If desired, the stabilizer may previously be hydrated in water. For this purpose the stabilizer solution is preferably heated. For this purpose the mixture is preferably heated to a temperature of 70 to 95° C., especially preferred to 85 to 95° C., mostly preferred to 90° C. The heating during this hydratization step is usually carried out for a duration of 0.1 to 5 minutes, preferably 0.2 to 4 minutes, even more preferred 0.3 to 3 minutes, mostly preferred 0.5 to 2 minutes.

Subsequently, the mixing is homogenized after heating. The homogenization serves for forming the protective sleeve between the protein molecules and the stabilizer molecules. Preferred homogenization conditions are 25 to 400 bar, especially preferred 30 to 300 bar, mostly preferred 50 to 250 bar.

The homogenization may take place simultaneously with the heating process. In this case the homogenization does not only take place at the cited pressures but also at the above-mentioned heating conditions.

It is preferred that the homogenization is carried out as a dual-stage process. Usually, the homogenization is thus carried out at 50/25 to 300/100 bar, preferably at 100/30 to 300/75, especially preferred at 150/50 to 250/50 bar. With this dual-stage process an improved distribution of the fats and an improved formation of the protective sleeve between the protein and the stabilizer may be obtained.

Then, the mixture is dried to obtain the protein powder according to the invention. For drying, conventional drying methods that are known in the prior art can be used. Conventional drying methods include spray drying, freeze drying, vacuum drying and roller drying. Especially preferred the mixture is spray-dried.

The drying conditions are not particularly restricted and may be modified respectively as long as a powder-like material can be obtained. Depending on the drying method, conventional method conditions, which are known to the person skilled in the art, are met.

Since the mixture is possibly very warm before the drying step, namely 70 to 95° C., it is also preferred for procedural reasons to cool the mixture before drying. It is sufficient if the mixture is cooled down to 15 to 30° C., preferably to 18 to 23° C., i.e. to ambient temperature.

It is possible that the pH value of the mixture before drying is lowered to <4.5, usually 4.3 to 4.0, even more preferred 4.1 to 3.8. The lowering of the pH value usually takes place by an acid. In view of the fact that the protein powder according to the invention shall be used in food industry, the acid should be harmless to health. Preferably, a culinary acid or a mixture of culinary acids is used.

Culinary acids are organic acids, which are versatilely used as flavor additives for fruity or other flavor combinations in the food production and in household. Conventional culinary acids are malic, tartaric, citric, acetic, lactic and fumaric acid. Especially preferred are lactic acid, citric acid, malic acid or tartaric acid, mostly preferred is lactic acid.

The lowering of the pH value is carried out by a conventional method. Usually, the acid is slowly added to the mixture and the pH value of the mixture is observed. As soon as the desired pH value has been reached the supply of acid is stopped.

This step usually takes place before drying, i.e. the pH value lowering can be carried out after mixing the protein source with the stabilizer in the liquid medium or after the optional hydratization step. Preferably, the pH value is lowered before heating, i.e. after the stabilizer and the protein source are mixed with one another.

The protein powder obtained thereby has a desired consistency, it is well perishable under conventional conditions and can be stored very easily. Particularly, it does not have to be processed immediately as opacifier or dietary supplement in a drink. A conventional shelf-life at temperatures of 18° C. to 23° C. is 6 to 12 months.

The effects according to the invention of the protein powder obtained in this manner particularly set in if it is processed to a protein-containing drink. The protein powder does not require complex storage conditions due to its dry form and it is perishable for a long period of time. Thus, it is extremely suitable for a drink production in industrial scale.

The drink in which the protein powder according to the invention is contained, is characterized by an appealing stable opacifier, without undesired flavorful changes or changes in terms of color occurring and sanitary concerns existing.

The drink according to the invention is obtained in that the protein powder according to the invention is solved in a liquid medium. From this a drink is produced in the conventional manner.

The liquid medium is usually the drink basis and is therefore preferably selected from non-alcoholic refreshment drinks or starting materials for this. This includes fruit juices, fruit nectars, fruit juice drinks, musts, non-alcoholic ferment drinks, vegetable drinks, teas and tea-like products, including fruit teas, black teas, green teas and kombucha products, extraction drinks, sweetened or unsweetened drinks on drinking water or mineral water basis with or without the addition of carbon dioxide, lemonades, caffeine-containing lemonades and cola drinks, tonic drinks, drinks including at least one of the following components: vitamins, trace elements, fibers and aromas, such as fruit or tea aromas. Fruit juices are characterized by a fruit content of 100%, fruit nectars have a fruit content of at least 20 to 50% and fruit juice drinks have a fruit content of at least 6%. These fruit juices or fruit-juice containing drinks are based on direct juices or fruit juice concentrates. The liquid medium is preferably selected from the group consisting of fruit juices or fruit nectars.

The protein powder according to the invention may also be solved only in drinking or mineral water and then the further additives that are required for producing the respective type of drink, are added. These supplements include, depending on the type of drink, preferably fruit juice concentrate, vegetable concentrate, tee concentrate, lemonade concentrate or cola concentrate, but vitamins, mineral nutritients, acid regulators, pectin, aromas can also be contained.

The protein powder is solved in the drink at a sufficient quantity to be suitable as opacifier or dietary supplements. Usually, the protein powder according to the invention exists in a quantity of 0.1 to 10 percent by weight, preferably 0.2 to 8 percent by weight, even more preferred 0.3 to 6 percent by weight, mostly preferred 0.5 go 5 percent by weight.

After the protein powder was solved, the liquid obtained is usually heated to make the drink perishable. For this purpose, the liquid is preferably heated to a temperature of 70 to 130° C., preferably 80 to 95° C., especially preferred 85 to 90° C.

The heating is usually carried out at 10 to 20 pasteurization units (for juices and acidic drinks), especially preferred with 10 to 15 PE. Formula for PE:
PE=t*^{1/z*(T-TB)}
T=pasteurization temperature [° C]
TB=reference temperature =80° C.
T=pasteurization time [min]
z=Z-value=10 (for juices)

In a final step the liquid is homogenized before the drink is bottled. Conventional homogenization conditions can be used that are known to the person skilled in the art in the production of drinks. Preferred homogenization conditions are described above in connection with the protein powder production.

Since the liquid is very hot after homogenization, namely e.g. 70 to 130° C., it is preferred for procedural reasons to cool the liquid before bottling. It is sufficient if the mixture is cooled down to 15 to 30° C., preferably to 18 to 23° C., i.e. to ambient temperature.

However, the drink may also be suitable for being consumed directly after solving the protein powder.

Moreover, it is possible that the pH value after solving the powder is acidified to <4.5. This step is not required if during production of the protein powder, as described above, the pH value was already lowered to <4.5.

The lowering of the pH value usually takes place with an acid. Preferred acid and procedural conditions are the same as described above in connection with the lowering of the pH value before drying the protein powder according to the invention.

The protein-containing drink according to the invention is characterized by a clear improvement with respect to shelf-like. Protein-containing drinks according to the invention may be stable between 20 and 24 weeks. This is not the case in drinks with conventional opacifiers on protein basis. Frequently, a clear sediment is observed in the bottling of such a drink. This effect can be eliminated to a limited extent only by homogenization. The drink is stable for a few weeks only. The reason for this lies in the already described heat damage of the proteins during drying.

The following examples explain the present invention.

### EXAMPLE 1

98.7 percent by weight of soy milk are mixed with 1.3 percent by weight of pectin. Subsequently, it is heated to 90° C. for 1 minute, then it is homogenized at 250/50 bar and cooled down to ambient temperature. In the subsequent spray drying process a powder is obtained from the liquid basis with a protein content of 40 percent by weight. Subsequently, 25 g of the protein powder obtained in this manner are solved in one liter fruit juice drink with a fruit content of 30 percent by weight, the pH value is set to pH 3.9 with citric acid and thus a protein-enriched drink is obtained. Subsequently a heating to 90° C. for 1 minute takes place and a homogenization at 250/50 bar. Subsequently, the drink is cooled down.

The stability of a drink obtained in this manner does not show the formation of a ring over 20 weeks. The stability is favorable in view of the sedimentation.

### EXAMPLE 2

97 percent by weight of soy milk are mixed with 1.3 percent by weight of pectin and are brought with 1.2 percent by weight of lactic acid to a pH value of 3.9. Subsequently, the mixture is heated to 90° C. for 1 minute, it is homogenized at 250/50 bar and cooled down to ambient temperature. In the subsequent spray drying process a powder is obtained from the liquid base with a protein content of 40 percent by weight.

Subsequently, 25 g of the protein powder obtained thereby are solved in one liter fruit juice drink with a fruit content of 30%, the pH value is set to 3.9 with Na-citrate and thus a protein-enriched drink is obtained. A heating to 90° C. for 1 minute takes place and a homogenization at 250/50 bar. Subsequently, the drink is cooled down.

The stability of a drink obtained in this manner does not show the formation of a ring for 24 weeks. The stability in view of the sedimentation is very good.

### COMPARATIVE EXAMPLE 1

20 percent by weight of soy milk are supplied with 0.2 percent by weight of pectin and are subsequently supplied to a fruit juice drink with a fruit content of 30 percent by weight, obtained from fruit juice concentrate. The pH value is set with citric acid to pH 3.9.

The mixture is heated to 90° C. for 1 minute, it is homogenized at 250/50 bar and subsequently cooled down to ambient temperature.

The stability of a drink obtained in this manner does not show the formation of a ring for 8 weeks. The stability in view of the sedimentation is moderate.

### COMPARATIVE EXAMPLE 2

60 percent by weight of concentrated soy milk are mixed with 37.4 percent by weight of water and 1.5 percent by weight of pectin and are brought to a pH value of 3.9 with 1.1 percent of weight of lactic acid. Subsequently, the mixture is heated to 90° C. for 1 minute, it is homogenized at 250/50 bar and cooled down to ambient temperature. 200 g/l of the liquid mixture are supplied with a fruit juice drink with a fruit content of 30 percent by weight obtained from fruit juice concentrate. The pH value is set to ph 3.9 with Na-citrate.

The drink is subsequently heated to 90° C. for 1 minute, it is homogenized at 250/50 bar and cooled down to ambient temperature

The stability of a drink obtained in this manner does not show the formation of a ring for 12 weeks. The stability in view of the sedimentation is acceptable.

### COMPARATIVE EXAMPLE 3

2.5 percent by weight of soy milk powder are supplied with 0.3 percent by weight of pectin and are subsequently directly given to a fruit juice drink with a fruit content of 30 percent by weight. The pH value is set with citric acid to pH 3.9.

The mixture is heated to 90° C. for 1 minute, it is homogenized at 250/50 bar and subsequently cooled down to ambient temperature.

The product obtained in this manner is not stable. A sediment forms immediately.

### COMPARATIVE EXAMPLE 4

12.5 percent by weight of soy milk powder is mixed with 1.5 percent by weight of pectin and is stirred into 84.9 percent by weight of water. The solution is brought with 1.1 percent by weight of lactic acid to a pH value of 3.9. Subsequently, the mixture is heated to 90° C. for 1 minute, it is homogenized at 250/50 bar and cooled down to ambient temperature.

200 g/L of the liquid mixture are supplied with a fruit juice drink with a fruit content of 30 percent by weight, obtained from fruit juice concentrate. The pH value is set with Na-citrate to pH 3.9.

The drink is subsequently heated to 90° C. for 1 minute, it is homogenized at 250/50 bar and cooled down to ambient temperature. The drink obtained in this manner is not stable. A sediment forms immediately.

1. A protein powder, including at least one protein source and one stabilizer, selected from esterified pectin and/or carboxylmethylcellulose, obtained by: mixing a protein source with a stabilizer, heating the mixtures homogenizing the mixture, and drying the mixture to obtain a powder, wherein the protein source consists of fresh milk selected from the group consisting of cow milk, sheep milk, goat milk, mare milk, whey, soy milk, oat milk and rice milk.

2. The protein powder as claimed in claim 1, characterized in that the mixing of the protein source with a stabilizer takes place in a liquid medium.

3. The protein powder as claimed in claim 1, characterized in that the pH value is lowered to <4.5 before drying.

4. The protein powder as claimed in claim 1, characterized in that the protein content in the protein powder exists in a quantity of 10 to 90 percent by weight.

5. The protein powder as claimed in claim 1, characterized in that the protein source is selected from the group consisting of cow milk, soy milk, whey and mixtures thereof.

6. The protein powder as claimed in claim 1, characterized in that the stabilizer in the protein powder exists in a quantity of 1 to 30 percent by weight.

7. A method of producing a protein powder, including at least one protein source and one stabilizer selected from esterified pectin and/or carboxylmethylcellulose, comprising the following steps: mixing the protein source with a stabilizer, heating the mixture, homogenizing the mixture, and drying the mixture to obtain a powder.

8. (canceled)

9. A method of producing a protein-containing drink, comprising the following steps: dissolving the protein powder according to claim 1 in a liquid medium, heating the liquid, and homogenizing the liquid, whereupon a protein-containing drink is produced.

10. The method as claimed in claim 9, characterized in that the liquid is acidified to a pH value of <4.5 after dissolving the powder.

11. (canceled)

12. A protein-containing drink, obtained by the method according to claim 9.
